(19) United States
(12) Patent Application Publication
(10) Pub. No.: US 2017/0096856 A1
(43) Pub. Date: Apr. 6, 2017

(54) LIFELINE BRACKET FOR LADDERS, LADDERS INCLUDING LIFELINE BRACKETS AND RELATED WORK PLATFORM SYSTEMS AND METHODS

(71) Applicant: Scott Libert, Waukesha, WI (US)

(72) Inventor: Scott Libert, Waukesha, WI (US)

(21) Appl. No.: 14/875,694

(22) Filed: Oct. 6, 2015

(51) Int. Cl. E06C 7/48; A62B 35/00; E04G 5/00; E06C 7/18

(52) U.S. Cl. CPC E06C 7/48; E06C 7/18; A62B 35/0068; E04G 5/001

(57) ABSTRACT

A bracket for a ladder includes a base member and an arm connected to the base member, the arm being at an angle relative to the base member, the arm comprising a first end having a clamp and a second end having a tethering structure. The base member has a shape configured to be positioned on a rung of a ladder with the clamp engaging a frame member of a work platform system.

### FIELD OF THE INVENTION

The present invention relates, generally, to the field of work platform system safety. More particularly, the present invention relates to structures capable of securing lifelines to ladders of work platform systems.

### BACKGROUND OF THE INVENTION

Lifelines, and particularly self-retracting lifelines are known and commonly used in conjunction with work platform systems, including particularly with access ladders for those work platform systems. Typically, when using an access ladder, a worker's lifeline is connected to a rail-and-carriage style system provided with the access ladder. This permits a worker to move up and down the access ladder. However, in order to be effective, these systems must be on or near the access ladder and often obstruct a worker's free mobility.

Other systems use freestanding structures, separate from the access ladders, to secure lifelines when using an access ladder. These systems move the lifeline to the back or side of a worker so that it is away from a worker's hands and body to provide less interference of the worker's free mobility. However, these systems also require additional set-up time and storage space.

For at least these reasons, therefore, it would be advantageous if a new or improved structure, system and/or method for securing lifelines while using access ladders could be developed that addressed one or more of the above-described concerns, and/or other concerns.

### SUMMARY OF THE INVENTION

In accordance with one embodiment, disclosed herein is a bracket for a ladder, the bracket comprising a base member and an arm connected to the base member, the arm being at an angle relative to the base member, the arm comprising a first end having a clamp and a second end having a tethering structure.

In accordance with a further embodiment, disclosed herein is a ladder comprising a plurality of rungs secured between frame members and a ladder bracket. The ladder bracket comprises a base member having an inverted U-shape forming a channel and an arm connected to the base member, the arm comprising a first end with a clamp and a second end with a tethering structure, wherein the arm being at an angle relative to the base member, and wherein the channel is positioned on at least one rung.

In accordance with a further embodiment, disclosed herein is a work platform structure comprising at least one work platform level comprising a flooring section and framework, the framework comprising a plurality of horizontal and vertical supports; at least one ladder section comprising a plurality of rungs; and a bracket for the ladder. The bracket comprises a base member having an inverted U-shape forming a channel; an arm approximately perpendicular to the base member, the arm comprising a first end having a clamp and a second end having a tethering structure; and a spacing member connecting the base member and the arm at a distance, wherein the channel of the base member is resting on one of the plurality of rungs on the ladder section and the clamp is secured to at least one of the supports of the work platform level framework.

In accordance with a further embodiment, disclosed herein is a method of erecting a work platform system comprising erecting a first level of the work platform system; installing a first ladder section; erecting a framework of a second level of the work platform system; installing a second ladder section; resting a ladder bracket on a rung of the second ladder section; and clamping the ladder bracket to a vertical support of the second level of the work platform system.

### BRIEF DESCRIPTION OF THE DRAWINGS

FIG. 1 is a perspective view of an embodiment of a lifeline bracket for ladders;

FIG. 2 shows a lifeline bracket for ladders installed on a ladder;

FIG. 3 is a cross-section view taken along line 3-3 of FIG. 2;

FIG. 4 shows a first embodiment of a work platform system including a ladder with a bracket;

FIGS. 5A and 5B show a second embodiment of a work platform system including a ladder with a bracket;

FIGS. 6A and 6B show a third embodiment of a work platform system including a ladder with a bracket; and

FIGS. 7-16 depict a process of erecting a work platform using a lifeline bracket.

### DETAILED DESCRIPTION

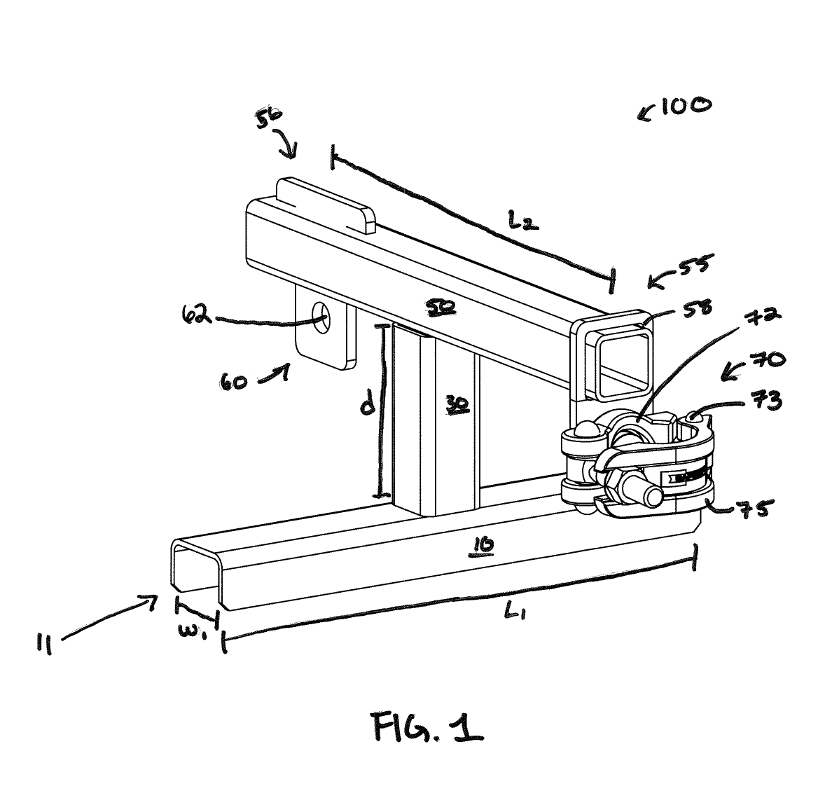

As shown in FIG. 1, a lifeline bracket for ladders 100 has a base member 10 and an arm 50 connected by a spacing member 30. One end of the arm 50 includes a clamp 70 for attachment to a work platform structure, and the opposite end of the arm 50 includes a tethering structure 60.

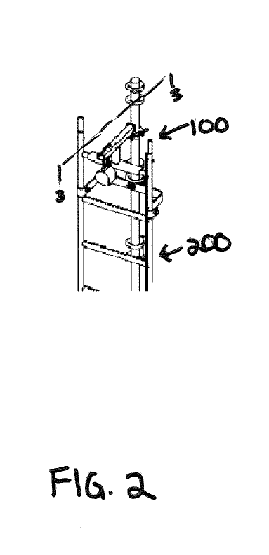

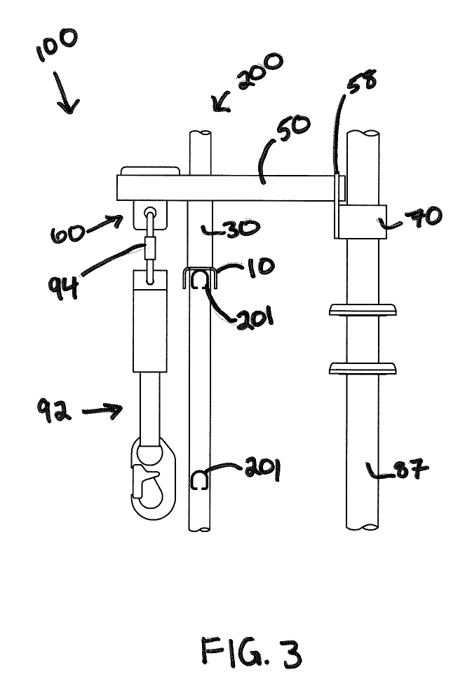

The base member 10 rests on or secures to a ladder. For example, in the embodiment shown in FIG. 1, the base member 10 has a shape designed to engage a ladder, and specifically a rung of a ladder. As shown, base member 10 has an inverted U-shape, which provides or forms a channel 11. As shown in FIGS. 2 and 3, the inverted U-shape allows the base member 10 to rest on the rung 201 of a ladder 200, with the rung 201 of the ladder 200 in the channel 11. Resting the base member 10 on a ladder rung 201 ensures proper alignment and orientation of the arm 50 relative to the ladder 200. In such an embodiment, the inner width of the inverted U-shaped channel corresponds to the outer width of a ladder rung, and the length of the base member 10 is less than the length of a ladder rung 201.

In an embodiment, the base member 10 has a length L₁ of from approximately 10, or 10.5, or 11, or 11.5 inches to 13, or 12.5, or 12, or 11.5 inches. In an embodiment, the base member 10 has a length L₁ of 11.5 inches.

In an embodiment, the base member 10 has an inner channel width W₁ of from approximately 0.75, or 1, or 1.25, or 1.5, or 1.75 inches to 2.5, or 2.25, or 2.0, or 1.75 inches. In an embodiment, the base member 10 has an inner channel width W₁ of 1.75 inches.

As illustrated in FIG. 1, the arm 50 is positioned at an angle relative to the base 10 such that a line extending from the first end 55 of the arm 50 to the second end 56 of arm 50 is not parallel with a line extending the length of base 10 if the arm 50 and base 10 were in the same plane. Specifically, in the embodiments shown, the arm 50 is positioned relative to the base member 10 such that a line extending from the first end 55 of the arm 50 to the second end 56 of the arm 50 is approximately perpendicular to, or perpendicular to, a line extending the length of the base 10 if the arm 50 and base 10 were in the same plane.

The approximately perpendicular placement of the arm 50 ensures that any lifeline connected to the tethering structure 60 remains behind the back of a worker climbing the ladder and so as not to obstruct the worker's vision or mobility. While in the embodiment shown the arm 50 is approximately perpendicular to, or perpendicular to, the base member 10, the arm 50 may be offset at an angle of up to +/−30°, or +/−25°, or +/−20°, or +/−15°, or +/−10° from perpendicular.

In an embodiment, the arm 50 is positioned at approximately 90°+/−30°, or +/−25°, or +/−20°, or +/−15°, or +/−10° relative to the base 10, such that a line extending from the first end 55 of the arm 50 to the second end 56 of the arm 50 intersects a line extending the length of the base 10 at an angle of 90°+/−30°, or +/−25°, or +/−20°, or +/−15°, or +/−10° if the arm 50 and base 10 were in the same plane.

In an embodiment, as shown in FIG. 1, the respective planes in which the base member 10 and arm 50 lie are parallel with one another. For example, with respect to the embodiment shown in FIGS. 2-4, the base 10 is in a first horizontal plane P₁ which is parallel with the ladder rungs 201 and arm 50 is in a second horizontal plane P₂ which is parallel with the ladder rungs 201.

In an embodiment, the arm 50 has a length L₂ from the center of the offsetting portion 58 to the center of the aperture 62 on the tethering structure 60 of from approximately 10.0, or 10.5, or 11.0 inches to 13.0, or 12.5, or 12.0, or 11.0 inches. In an embodiment, the length L₂ of the arm 50 is from approximately 11.0, or 11.2, or 11.32 inches to 11.5, or 11.4, or 11.32 inches. In an embodiment, the length L₂ of the arm 50 is 11.32 inches.

In the embodiment shown in FIG. 1, the arm 50 and base member 10 are separated by distance d. Spacing member 30 connects and separates the arm 50 and base member 10. Separating the arm 50 from the base member 10 ensures that the arm 50, and therefore tethering structure 60 and, ultimately, a lifeline, are situated above the ladder rung to which the bracket 100 is placed, typically a top ladder rung.

In an embodiment, the distance d is from approximately 10, or less than 10, or 8, or 5, or 4.5, or 4 inches to 0 inches, or greater than 0 inches, 2 inches, or 3, or 3.5, or 4 inches. In an embodiment, the distance d is 4 inches, or 4.0 inches.

Providing a distance between the base member 10 and the arm 50 assists in a number of ways. First, the distance allows a clearance space for a worker's head and upper body when climbing the ladder and/or tools are being carried or hauled up the ladder or in proximity to the ladder. Second, the distance assists in maintaining unobstructed access to the desired work platform level. Third, the distance assists in ensuring a lifeline attached to the bracket 100 cannot become slack even when a worker reaches the desired level of the work platform. If the base member 10 and arm 50 are not separated by a distance, additional ladder sections may be required in order to ensure the bracket 100 is installed at a high enough level so that a worker's lifeline does not go slack upon accessing the desired work platform level.

In the embodiments shown in FIG. 1, base member 10 and arm 50 are generally oriented horizontally with respect to a ladder rung, as illustrated more fully in FIGS. 2-4. In most uses, ladders are positioned generally perpendicular to or at an inclined angle relative to the ground or other surface, such that each rung of the ladder is in a plane generally horizontal to the plane of the ground or other surface. In other words, ladder rungs are each generally horizontal to the ground or other surface. As a result, when the base 10 of the bracket 100 is positioned on a ladder rung 201, whether directly or indirectly, both the base 10 and arm 50 are therefore generally horizontal with respect to the ground or other surface as well.

In such embodiments when the base 10 and arm 50 are generally horizontal with respect to the ground, spacing member 30 is generally vertical with respect to the ground.

Clamp 70 is secured at a first end 55 of the arm 50 and used to secure the bracket 100 to a work platform structure 80. For example, in the embodiment shown in FIG. 2, the clamp 70 is connectable to a support, and preferably a support which is generally perpendicular to the pane of the base member 10, such as a master post 87 for the work platform structure 80.

In the exemplary embodiment shown, the clamp 70 contains two portions—a stationary portion 72 which is attached to the horizontal arm 50 at vertical plate 58 and a pivotal portion 75 which is connected to the stationary portion 72 at pivot 73. In the embodiment shown, pivot 73 is a pin. Clamp bolt 76 joins the stationary portion 72 and pivotal portion 75 and tightens the clamp 70 around a structure, such as a support of a work platform structure 80. Specifically, in the embodiment shown, clamp bolt 76 is tightened to approximately 40-45 ft-lb.

In an embodiment, the clamp 70 is a half swivel clamp.

As shown in FIG. 1A, clamp 70 is connected to the first end 55 of the arm 50 via offsetting portion 58, resulting in clamp 70 being positioned between the plane of the arm 50 and the plane of the base 10. More particularly, clamp 70 is spaced above and offset from base 10. In other words, as shown in the embodiments illustrated in FIGS. 2-4, when a bracket 100 is positioned, either directly or indirectly, on a ladder 200 which is approximately vertical with respect to the ground, the offsetting portion 58 is also approximately vertical with respect to the ground such that the clamp 70 is at a vertical position between the base 10 and arm 50.

In an embodiment, the clamp 70 is connected to the offsetting portion 58 using a nut and bolt or nut and pivot stud. In an embodiment, the nut is tightened to the bolt with 10 to 15 ft-lb. force.

Tethering structure 60 is provided on the second end 56 of the arm 50, opposite the clamp 70. Lifelines and other safety harnesses/tie-offs are secured to the tethering structure 60.

In the exemplary embodiment shown, tethering structure 60 is a plate which is approximately perpendicular to, or perpendicular to, arm 50. For example, in the embodiments illustrated in FIGS. 2-4 in which the bracket 100 is positioned, directly or indirectly, on a ladder 200, the tethering structure 60 is approximately vertical, or vertical, with respect to the ground. In the embodiment shown, the tethering structure 60 contains a single aperture 62 to which a lifeline can be secured. For example, a lifeline may be connected to the tethering structure 60 via aperture 62 by a carabiner, other clip or clasp, or other structure or device known and commonly used in the art. As illustrated in the exemplary embodiment shown in FIG. 3, a lifeline 92, which is a self-retracting lifeline, is connected to the bracket 100 via carabiner 94 at aperture 62 of the tethering structure 60.

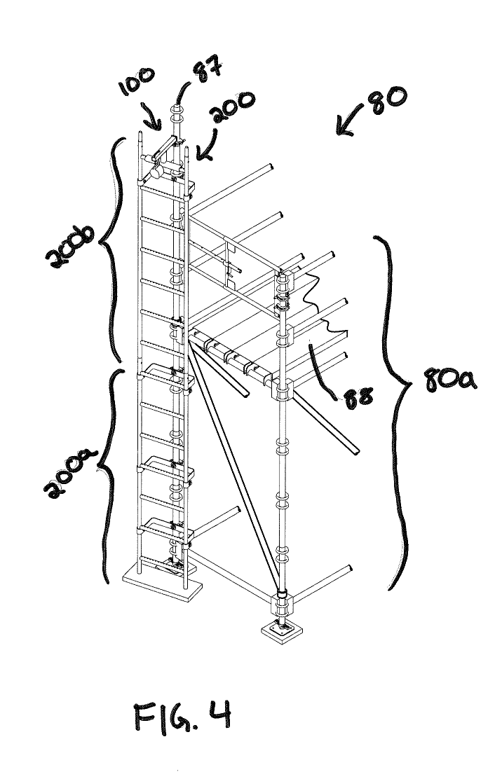

FIG. 4 shows the bracket 100 in use on a ladder 200 with a work platform structure 80. In the embodiment shown, two ladder sections 200a, 200b are installed to reach a first level 80a of the work platform structure 80. The base member 10 of the bracket 100 is resting on the rung 201 of the second ladder section 200b, and the clamp 70 is tightened around the master post 87. When additional levels of the work platform structure 80 are used, the bracket 100 is generally placed on the top-most ladder section.

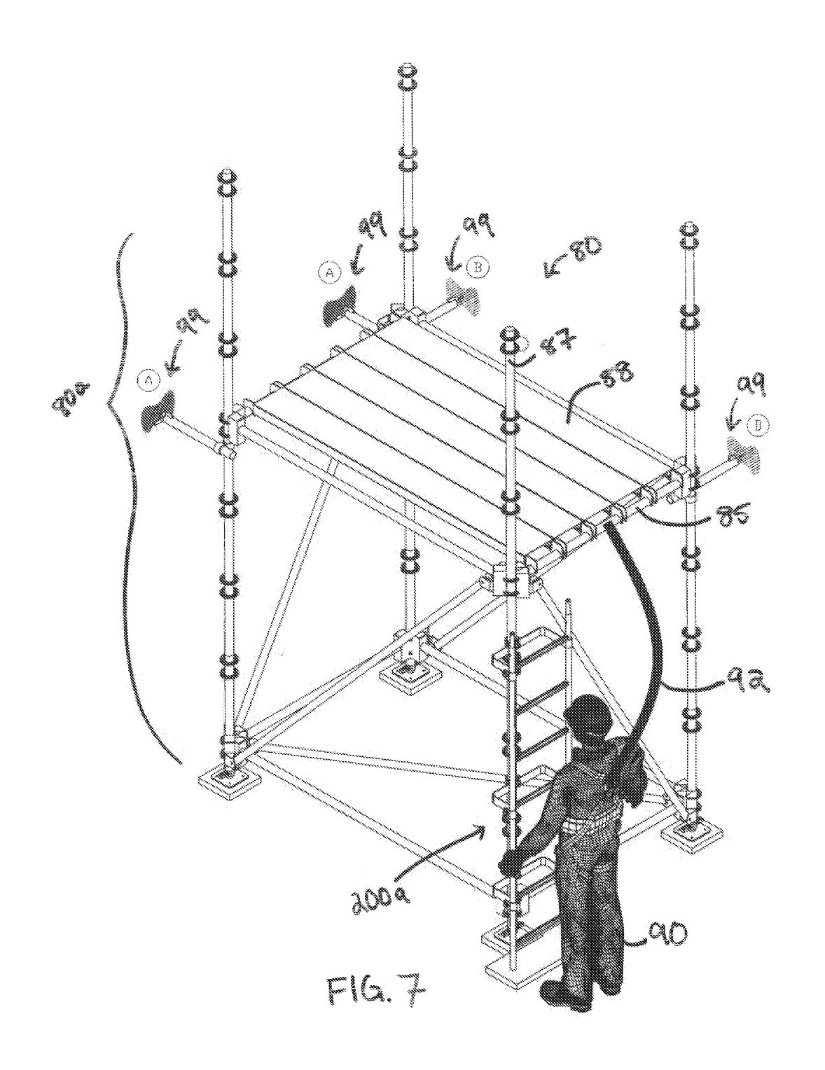

As illustrated, the ladder 200 is a standard ladder used with work platform systems. The ladder 200 includes a vertical frame 202 between which are a plurality of horizontal rungs 201. The work platform 80 includes a plurality of horizontal (85) and vertical (87) supports with a flooring section (88) forming a first level 80a of the work platform 80 (see, for example, FIG. 7).

In the embodiment shown in FIG. 4, the ladder 200 is attached to the master post 87, which forms a support for the work platform 88 itself. As a result, the ladder 200 is at an angle of less than 90° relative to the work platform 88.

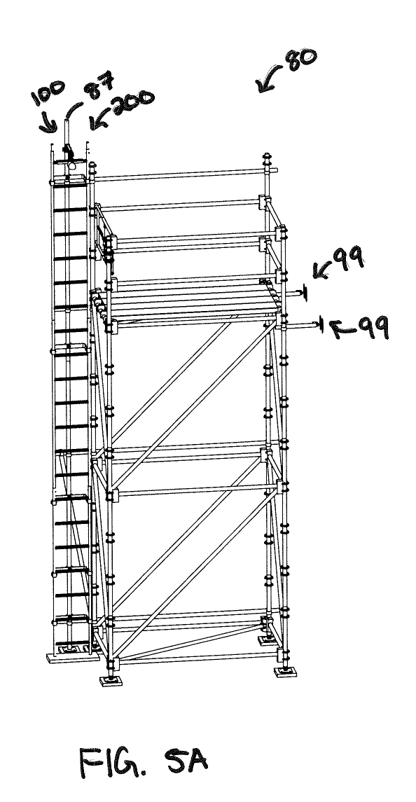

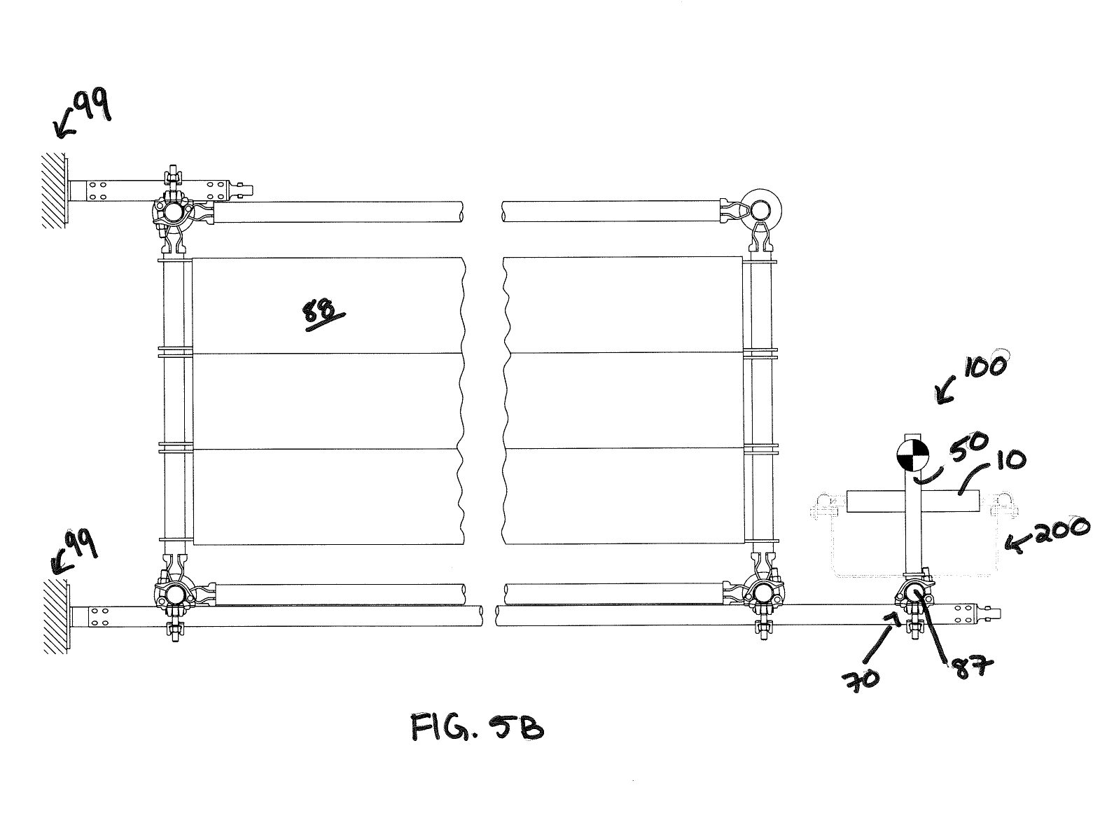

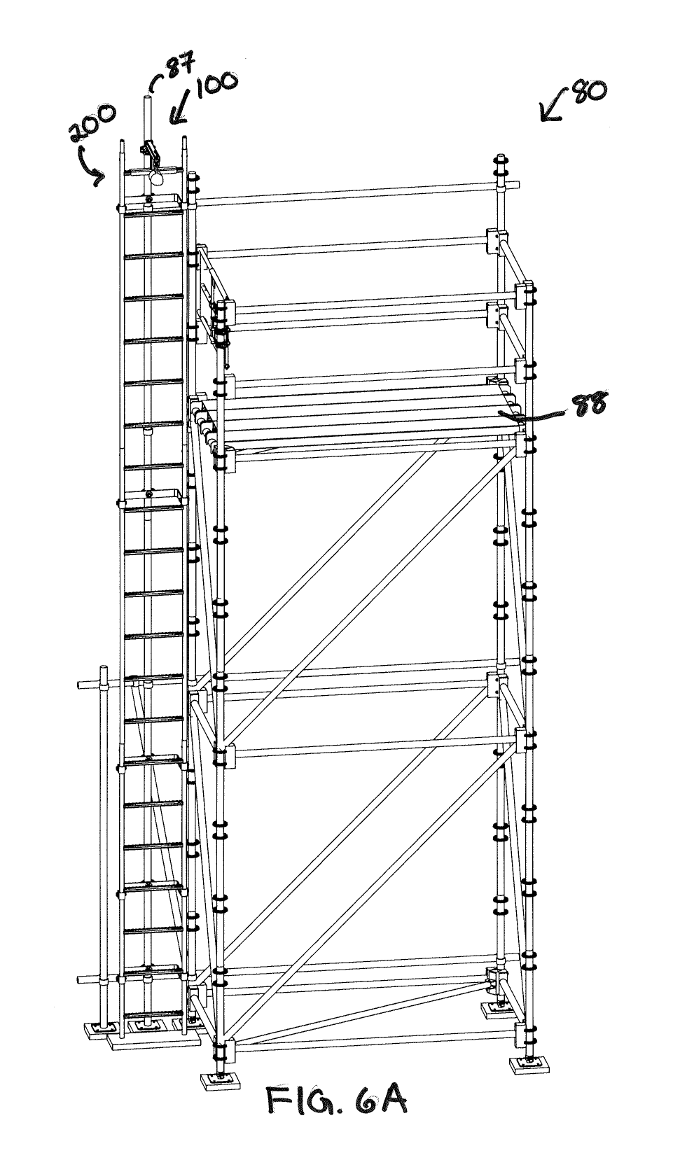

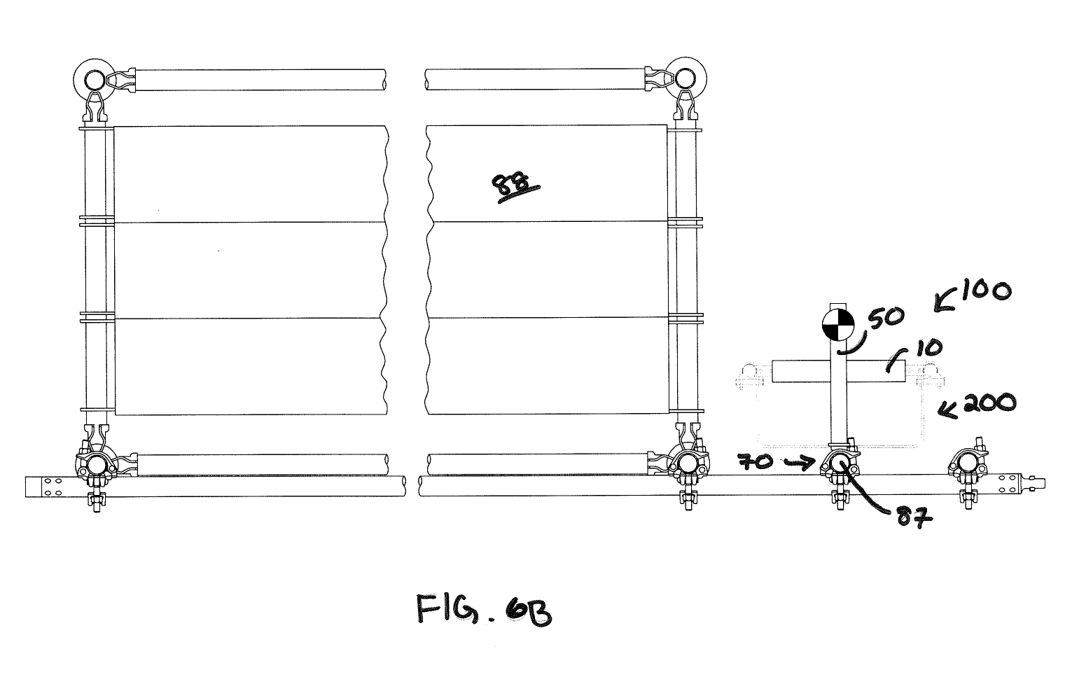

FIGS. 5A-6B illustrate alternative embodiments of a work platform system in which the ladder 200 is at an angle of 90° relative to the work platform 88. In the embodiment shown in FIGS. 5A and 5B, the work platform system is secured to a structure (e.g., building) at points 99. In the embodiment shown in FIGS. 6A and 6B, the work platform system is freestanding. As shown in FIGS. 5A-6B, the ladder 200 is secured to support 87, which is a vertical support that does not directly from a support for the work platform 88 itself. With such a configuration, the ladder 200 may be placed at a 90° angle relative to the work platform 88. Having the ladder 200 at 90° relative to the platform 88 assists in increasing the accessibility of the platform 88 when moving from the ladder 200 to the platform 88.

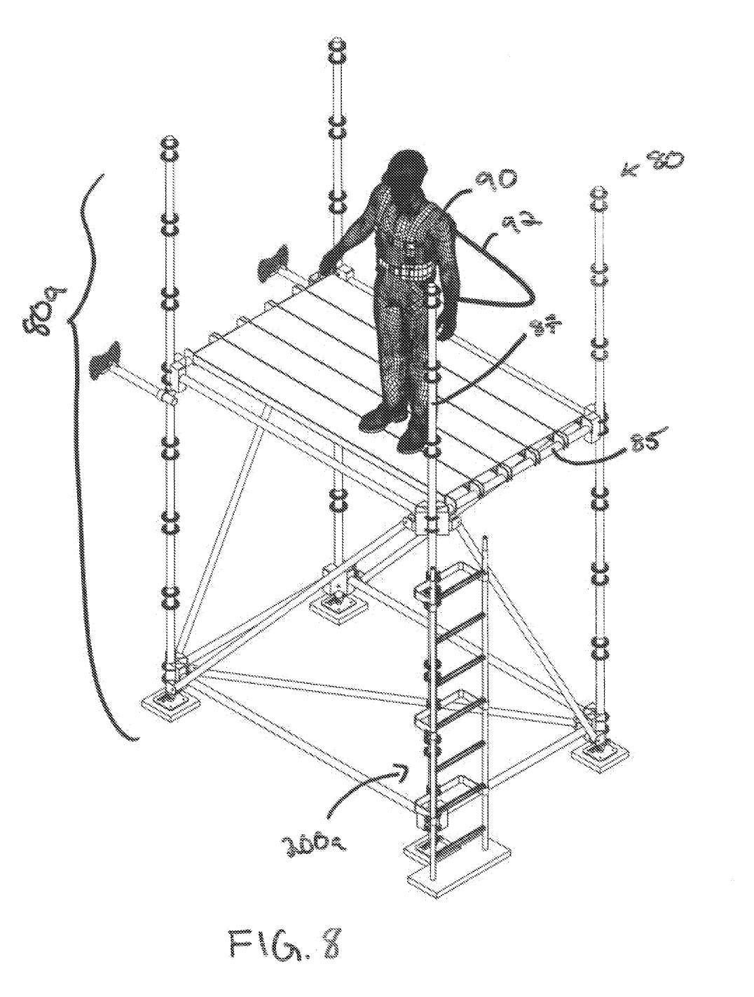

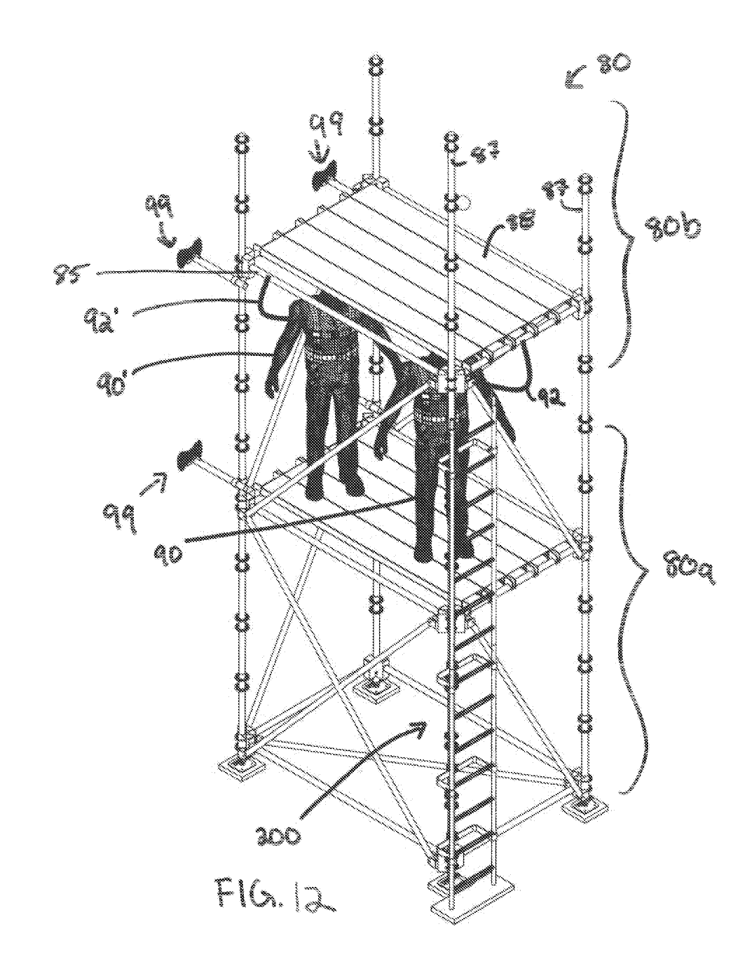

FIGS. 7-16 illustrate the process of erecting a work platform structure 80 using a lifeline bracket 100. In a first step, a first level 80a of the work platform 80 is erected from a ground/base and a first ladder section 200a is installed. In the embodiment shown in FIGS. 7-16, the work platform system 80 is secured to a structure, such as a building or further portions of a work platform system, at points 99. As seen in FIG. 7, the lead erector 90 has a lifeline 92 which is attached to a structural member of the work platform structure 80, such as the horizontal (85), near the ladder section 200a. Once atop first level 80a, the lead erector 90 moves his lifeline 92 to a master post 87, as in FIG. 8. In the exemplary process shown, the master post 87 is the post to which the ladder 200 is secured.

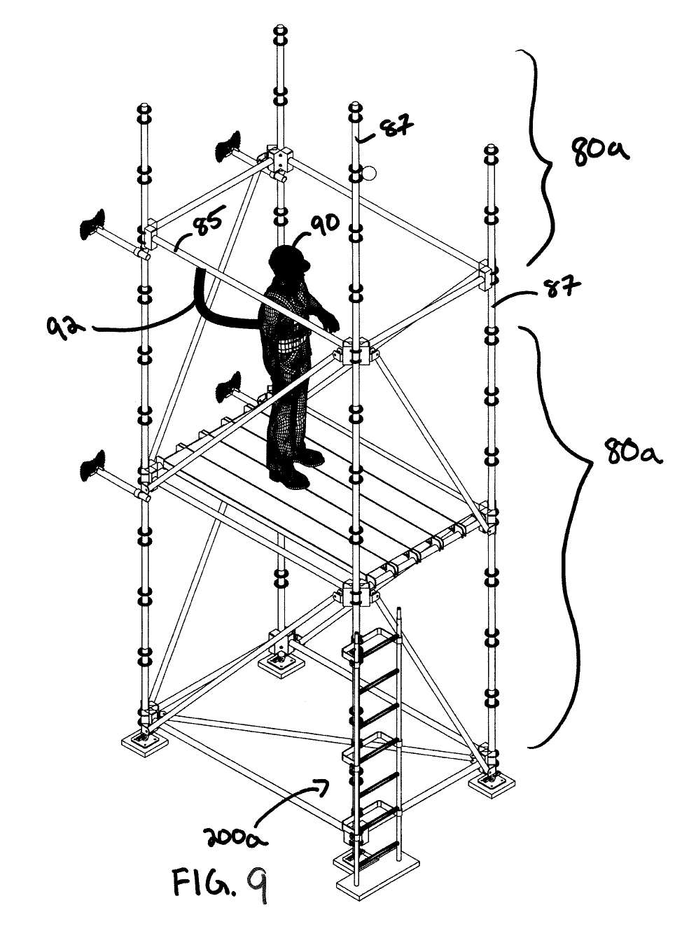

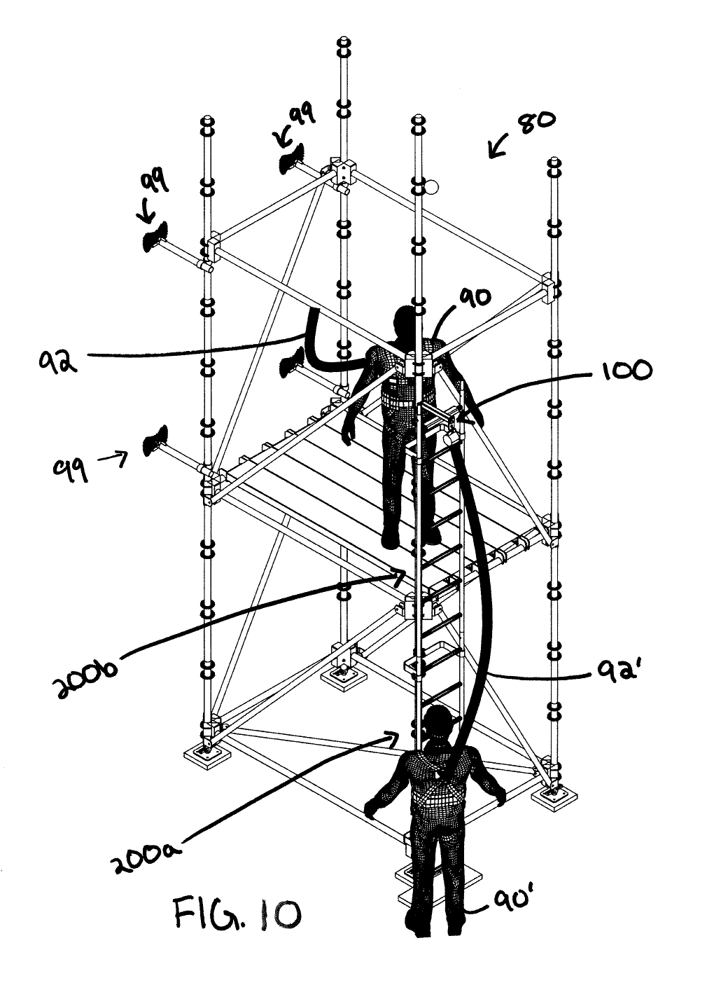

The lead erector 90 then begins to assemble the second level 80b of the work platform 80 and attaches the lifeline 92 to a structural member of the work platform structure 80 (e.g., a horizontal (85)) (FIG. 9). The second ladder section 200b is then installed and the lifeline bracket for ladders 100 is installed on the top of the second ladder section 200b (FIG. 10).

To install the bracket for ladders 100, the bracket 100 is first placed on a rung 201 of the ladder 200. In the embodiment shown, the bracket 100 is placed on the uppermost rung 201 of the second ladder section 200b. In an embodiment, the bracket 100 comprises a base member 10 which rests on the rung 201. In a further embodiment, the base member 10 has an inverted U-shape forming a channel, and the channel rests on the rung 201 of the ladder 200. Once the bracket 100 is properly positioned on the ladder 200, the clamp 70 of the bracket 100 is tightened to the work platform 80. Specifically, in the embodiment shown, the clamp 70 is tightened to a support (e.g., the master post 87) of the work platform 80. In an embodiment, the clamp 70 is tightened to approximately 45 ft-lbs.

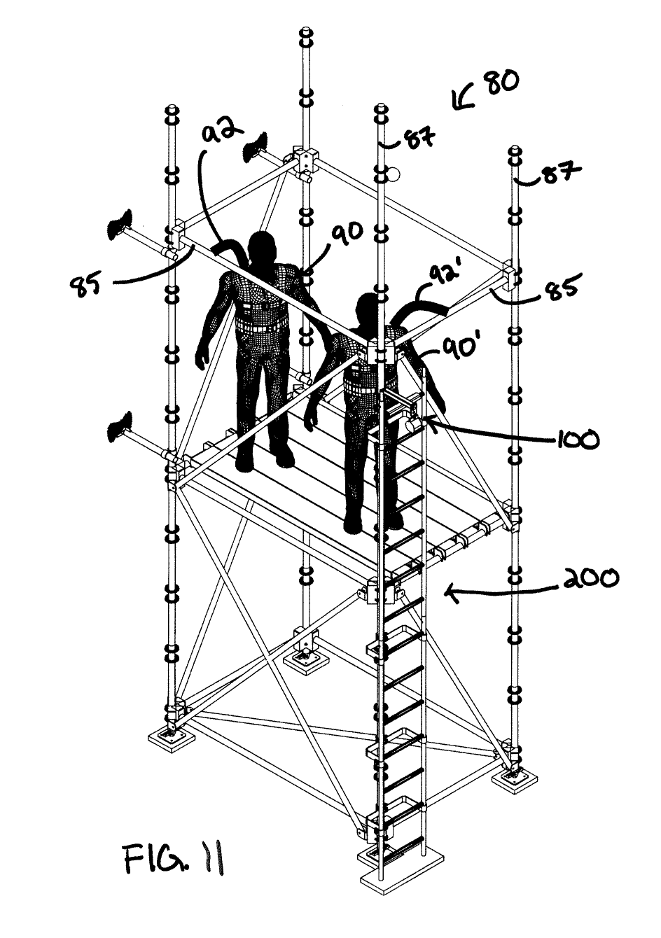

As illustrated in FIGS. 10 and 11, to assist in erecting the work platform 80, a second worker 90′ can connect a lifeline 92′ to the bracket 100 and climb the ladder 200 to the lead erector 90. The second worker's 90′ lifeline 92′ is then connected to a structural member of the work platform structure (e.g., horizontal (85)), like the lead erector 90.

In an embodiment, the bracket 100 is removed from the second ladder section 200b to provide room to erect the second level 80b of the work platform 80 and allow the planks which form the flooring to be assembled on the frame (FIG. 10).

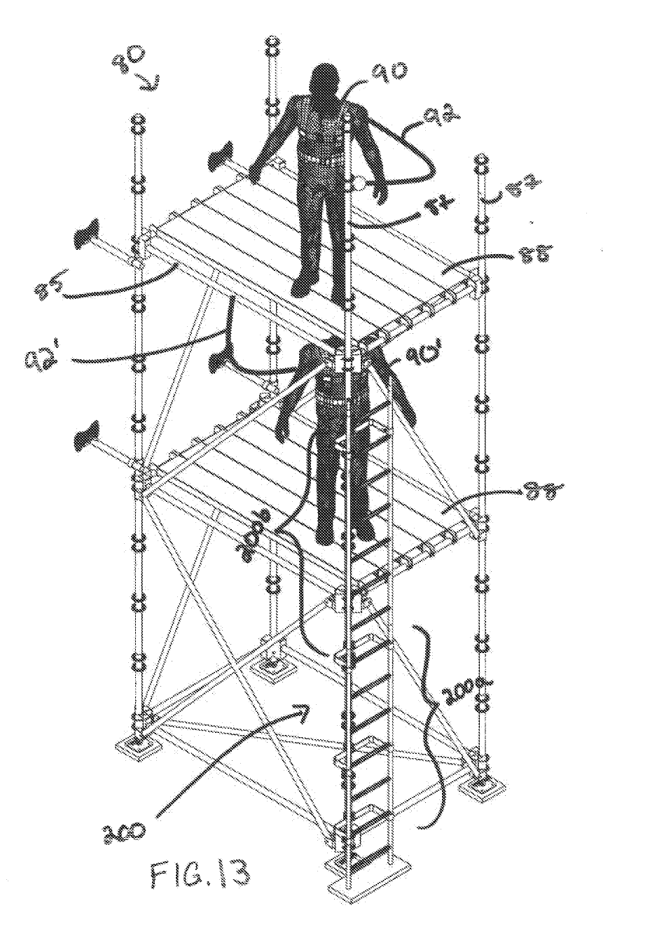

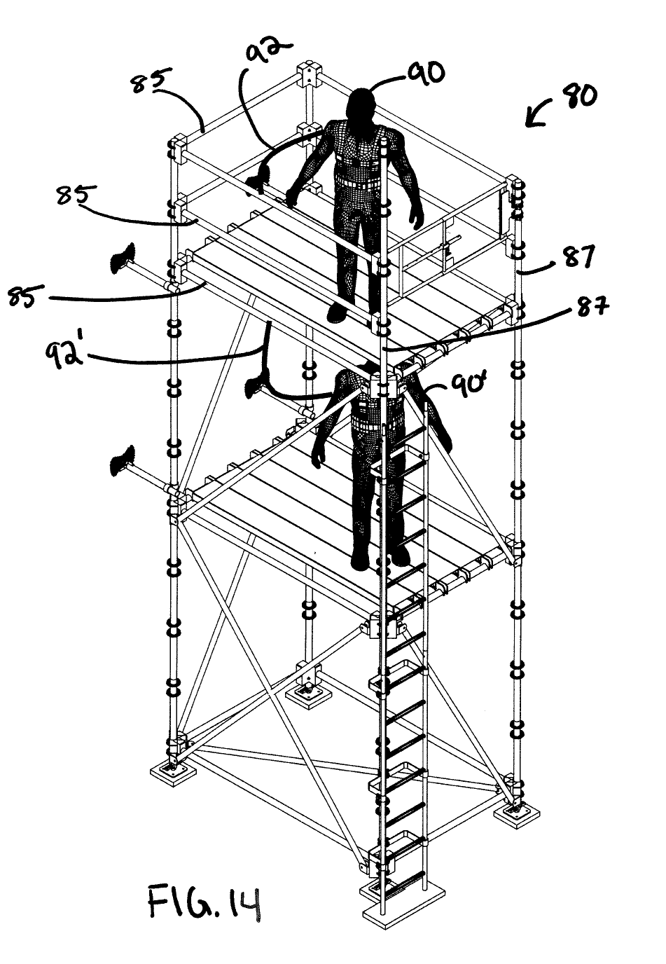

As shown in FIG. 13, the lead erector 90 then climbs to the second level 80b of the work platform 80 and attaches his/her lifeline 92 to the master post 87. After installing the necessary rails 89, the lead erector 90 detaches his/her lifeline 92 from the master post 87 and attaches it to a structural member of the work platform structure 80 (e.g., horizontal (85)) (FIG. 14). In the embodiment shown, the lead erector 90 installs a rail system for the second level 80b of the work platform 80. However, if additional levels of the work platform 80 are to be erected, the lead erector 90 would erect a framework for a third level (or other subsequent level) of the work platform 80.

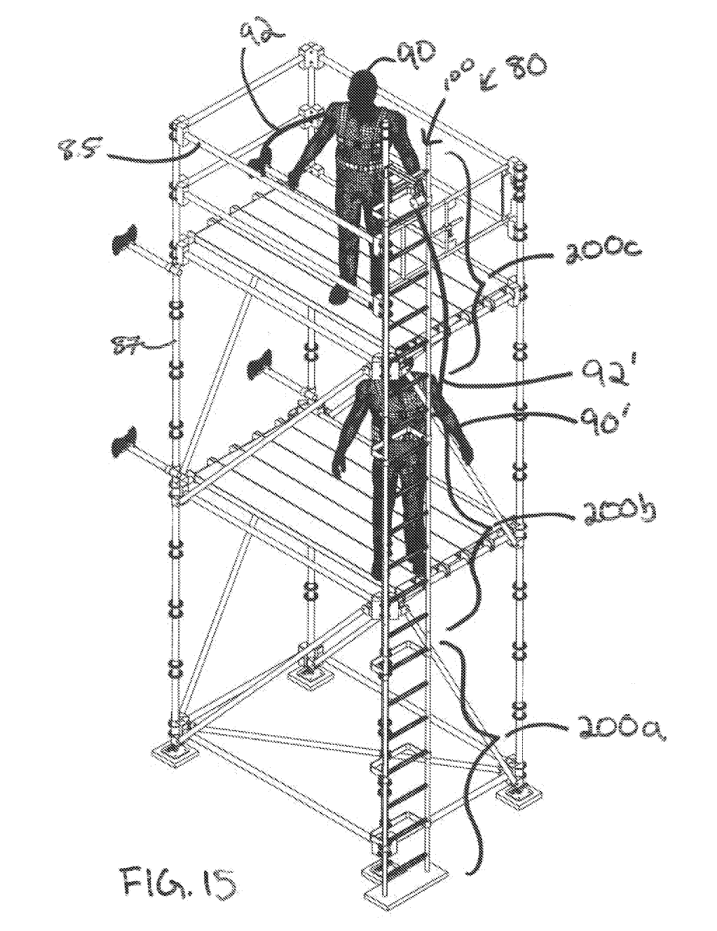

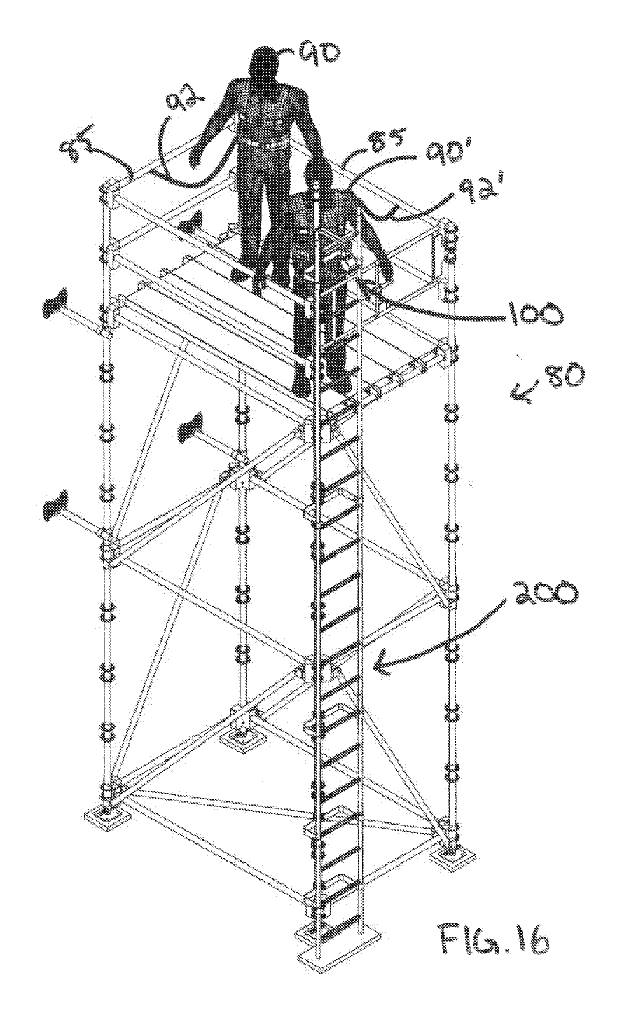

A third ladder section 200c is installed (FIG. 15) with a bracket 100. If a second worker 90′ is assisting, the second worker's 90′ lifeline 92′ can then be attached to the bracket 100. The second worker 90′ then joins the lead erector 90 and attaches his/her lifeline 92′ to a structural member of the work platform structure (e.g., horizontal (85)), as in FIG. 16.

To erect further levels, the process depicted in FIGS. 7-16 is repeated as appropriate.

While the lifeline 92 described herein and depicted in the figures is a self-retracting lifeline having a carabiner 94 which connects the lifeline 92 to the bracket 100, it is understood that other lifelines (e.g., non-self-retracting) may be used with the bracket 100.

The numerical ranges disclosed herein include all values from, and including, the lower value and the upper value. For ranges containing explicit values (e.g., 1 or 2, or 3 to 5, or 6, or 7) any subrange between any two explicit values is included (e.g., 1 to 2; 2 to 6; 5 to 7; 3 to 7; 5 to 6; etc.).

Among other things, it should be appreciated that the scope of the present disclosure is not limited to the number of constituting components, the materials thereof, the shapes thereof, the relative arrangement thereof, etc., as described above, but rather the above disclosures are simply provided as example embodiments. Further, any statements provided regarding clearance or other features which may provide improved safety are not intended to guarantee, warrant or represent the safety of the bracket disclosed herein

Thus, it is specifically intended that the present invention not be limited to the embodiments and illustrations contained herein, but include modified forms of those embodiments including portions of the embodiments and combinations of elements of different embodiments as come within the scope of the following claims.

What is claimed is:

1. A bracket for a ladder, the bracket comprising:
a base member having a first end and a second end,
an arm connected to the base member, wherein the arm is at an angle relative to the base member, the arm comprising
a first end having a clamp, and
a second end having a tethering structure.

2. The bracket of claim 1, wherein the arm is at an angle of 90° relative to the base member such that a line extending from the first end of the base member to the second end is perpendicular to a line extending from the first end to the second end of the arm if the base and arm were in the same plane.

3. The bracket of claim 1, wherein the base member has an inverted U-shape forming a channel.

4. The bracket of claim 3, wherein the clamp comprises a stationary portion; a pivotal portion connected to the stationary portion at a pivot point; and a clamp bolt.

5. The bracket of claim 4, wherein the tethering structure comprises a plate and an aperture.

6. The bracket of claim 5, wherein the base member and the arm are perpendicular.

7. The bracket of claim 6, wherein the base member and the arm are connected by a spacing member.

8. The bracket of claim 7, further including a lifeline secured to the tethering structure.

9. The bracket of claim 8, wherein the lifeline comprises a self-retracting lifeline and a carabiner and wherein the carabiner is secured to the aperture of the tethering structure.

10. A bracket for a ladder, the bracket comprising:
a base member having an inverted U-shape forming a channel;
a arm approximately perpendicular to the base member, the arm comprising a first end having a clamp and a second end having a tethering structure; and
a spacing member connecting the base member and the arm at a distance.

11. The bracket of claim 10, wherein the clamp comprises a stationary portion, a pivotal portion connected to the stationary portion at a pivot point, and a clamp bolt.

12. The bracket of claim 10, wherein the tethering structure comprises a plate and a lifeline-engaging aperture.

13. A ladder comprising:
a plurality of rungs secured between frame members; and
a ladder bracket comprising
a base member having an inverted U-shape forming a channel,
a arm connected to the base member, the arm comprising a first end with a clamp and a second end with a tethering structure, wherein the arm is perpendicular to the base member,
wherein the channel is positioned on at least one rung.

14. The ladder of claim 13, wherein the channel is positioned on the uppermost rung.

15. The ladder of claim 14, further comprising a lifeline secured to the ladder bracket.

16. The ladder of claim 15, wherein the lifeline is a self-retracting lifeline.

17. The ladder of claim 16, wherein the tethering structure comprises a plate with an aperture and the lifeline is secured to the aperture.

18. A work platform structure comprising:
at least one work platform level comprising a flooring section and framework, the framework comprising a plurality of horizontal and vertical supports;
at least one ladder section comprising a plurality of rungs; and
a bracket for the ladder, the bracket comprising
a base member having an inverted U-shape forming a channel;
a arm approximately perpendicular to the base member, the arm comprising a first end having a clamp and a second end having a tethering structure; and
a spacing member connecting the base member and the arm at a distance,
wherein the channel of the base member is resting on one of the plurality of rungs on the ladder section and the clamp is secured to at least one of the supports of the work platform level framework.

19. A method of erecting a work platform system comprising:
erecting a first level of the work platform system;
installing a first ladder section;
erecting a framework of a second level of the work platform system including a vertical support;
installing a second ladder section;
resting a ladder bracket on a rung of the second ladder section; and
clamping the ladder bracket to a vertical support of the second level of the work platform system.

20. The method of claim 19 further comprising:
connecting a lifeline to the ladder bracket.

21. The method of claim 20 further comprising:
removing the lifeline from the ladder bracket;
installing a flooring section on the framework of the second level of the work platform system;
erecting at least one of a framework of a third level of the work platform system and a rail system for the second level of the work platform system;
installing a third ladder section;
resting the ladder bracket on a rung of the third ladder section; and
clamping the ladder bracket to a vertical support of the at least one of the framework of a third level of the work platform system and a rail system for the second level of the work platform system.

22. The method of claim 21, wherein the step of erecting at least one of a framework of a third level of the work platform system and a rail system for the second level of the work platform system comprises erecting a rail system for the second level of the work platform system.

23. The method of claim 21, wherein the step of erecting at least one of a framework of a third level of the work platform system and a rail system for the second level of the work platform system comprises erecting a framework of a third level of the work platform system.

24. The method of claim 23, wherein the steps of connecting a lifeline to the ladder bracket; removing the lifeline from the ladder bracket; installing a flooring section on the framework; erecting at least one of a framework and a rail system; installing a ladder section; resting the ladder bracket and clamping the ladder bracket are repeated with respect to the third level of the work platform system.
